(19) United States
(12) Patent Application Publication
(10) Pub. No.: US 2010/0154285 A1
(43) Pub. Date: Jun. 24, 2010

(54) DEFORMABLE FISHING LURE

(76) Inventor: Thomas Greenfield, Sanora, CA (US)

Correspondence Address: BRUCE A. JAGGER;Brooks Kushman P.C., 1000 Town Center, 22nd Floor, Southfield, MI, 48075, US

(21) Appl. No.: 12/338,886

(22) Filed: Dec. 18, 2008

(51) Int. Cl. A01K 85/00

(52) U.S. Cl. 43/42.24; 43/42.36

(57) ABSTRACT

A fishing lure capable of mimicking various motions of a wounded or distressed fish in the water. The lure may resemble a prey fish, worm or other natural food, and includes a flaccid elastomeric body having a front end, a tail end. and a tail section. The fishing lure includes a spine extending lengthwise through some, but not all, of the elastomeric body. The spine allows a fisherman to shape the lure by hand to a motion defining configuration that will cause motion that simulates that of a wounded or distressed prey fish or other natural food. The elastomeric body is not rigid enough to sustain a motion defining shape without the spine. The spine extends forward of the front end of the lure and exits the elastomeric body of the lure near the tail section, but not at the rear end of the lure. The spine does not support the tail section. The tail section is free to flutter in the water as the fishing lure is drawn through the water. The spine has a forward hole adjacent its forward end and a rear hole adjacent its rear end. The spine projects far enough from the front end of the lure to permit a fishing line to be attached to it by conventional means. The hole at approximately the rear end of the spine permits a fishhook to be attached to it. The positioning of this rear hole relative to the body of the lure is such that it allows an attached fishhook to extend approximately to the rear of the lure. Also, the attachment of the fishhook to the hole is such that the fishhook is free to flutter as it moves through the water. The attachment of a small piece of frozen bait to the fishhook provides a real prey fish or other natural food scent to the fishing lure and further induces a predator fish to strike the fishing lure.

### BACKGROUND OF THE INVENTION

(1) Field of the Invention

The present invention relates to the field of fishing lures comprised of a soft, flaccid, elastomeric body configurable to mimic the erratic movement of a wounded or distressed fish, worm, or other prey in the water.

(2) Description of the Related Art

The sport fishing industry is funded mainly by fisherman eager to obtain any advantage when catching fish. In the fishing lure arts various lures have been proposed that depend for their utility on mimicking some one or more characteristics exhibited by the natural food that the intended fish normally feeds on. For example, predator fish are genetically programmed to feed, when possible, on wounded or “distressed” prey fish or other live food sources. For example when a salmon feeds it will attack or strike a bait ball, gnashing with its teeth and slashing at the bait ball with its tail. A wounded or distressed prey fish, for example, often rolls, spins, wobbles or exhibits some other motion that is not typical of its normal motion. Such non-normal motion attracts predator fish that strike at the prey fish. Smell is another characteristic of natural food that often attracts fish.

There have been many developments in the fishing lure arts. The Gil Hooley Easy Baiter, for example, comprises a threader, which is a strip of thin metal, with a hole at each end, a leader and hook attached to one hole and a swivel attached to the other hole. The swivel is detached, the threader pushed through the bait (which can be a worm or plastic worm), and the swivel reattached. The bait rides on the hook at the end of the leader and the threader acts as an additional attractant.

U.S. Pat. No. 3,023,534 issued Mar. 6, 1962 to Smith (and is hereby incorporated herein by reference as though fully set forth hereat) discloses a fishing lure adapted to be formed at will by a fisherman to various lure shapes. The disclosed lure comprises a sheet of hand bendable metal material having a lead end, a follow end, and a central point of line attachment. There is a slot formed inwardly in each of the ends to a depth in excess of one half the distance to the central point of attachment. This forms a pair of wings with nose fins and tail fins, all of which are hand formable and alterable at will. There is also a pull rod having a length in excess of the length of the sheet and rigidly attached substantially centrally to the central point of attachment. The pull rod is bendable upwardly through the slots at will for additionally controlling maneuvers and gyrations of the formed lure. The disclosed lure does not, in either appearance or feel resemble any natural food for predator fish.

U.S. Pat. No. 4,791,749 issued Dec. 20, 1988 to Stazo (and is hereby incorporated herein by reference as though fully set forth hereat) discloses fishing lures which have a leadhead with a shaft embedded therein and extending therefrom. A soft polymeric body is replaceably mounted on the shaft. The shaft extends at least part way through the soft body. A fishhook is attached to an end of the shaft that extends through the soft body.

U.S. Pat. No. 5,077,930 issued Jan. 7, 1992 to Berry (and is hereby incorporated herein by reference as though fully set forth hereat) discloses a fishing lure having a substantially flat, bendable elongated body of rigid, hard, molded lead. Eyelets are attached to the ends of the lure by being partially embedded in the body. The elongated relatively heavy body has a cross section with a major axis and a minor axis about which the body may be manually bent. Casting is facilitated by the weight of the lead body.

U.S. Pat. No. 5,084,997 issued Feb. 4, 1992 to DiPaola (and is hereby incorporated herein by reference as though fully set forth hereat) discloses a fishing lure with a flexible body portion. The flexible body portion has a flexible core element from which radially extending flexible fibers project. The body portion, further, has memory characteristics such that it can be shaped into various configurations and can travel through water and remain in a set configuration.

U.S. Pat. No. 5,412,901 issued May 9, 1995 to Matinez (and is hereby incorporated herein by reference as though fully set forth hereat) discloses a fishing lure having an elongate deformable lead body. This disclosure suggests that the depth of the lure and the path traveled by the lure in a body of water, when the lure is pulled through the water, may be adjusted by changing the shape of the deformable lead body. A stainless steel shank extends through the deformable body to facilitate the mounting of one or more spinners and colored beads on the lure. A loop with a coil spring closure mechanism is formed at the end of the shank to permit connecting a hook to the lure.

U.S. Pat. No. 6,058,645 issued May 9, 2000 to Lummis (and is hereby incorporated herein by reference as though fully set forth hereat) discloses an elongated fishing lure having an elongate and buoyant core, and a plastic bendable strand of wire extending the length of the lure. A first eyelet is provided at a first end of the wire, a second eyelet is provided at a second end, and a third eyelet is located intermediate the first and second ends. A soft pliable body encases the core while simultaneously maintaining the first, second and third eyelets exposed relative to an exterior of the body. First and second rigid side body panels are mounted on opposite sides of the body. These panels conform in shape to the body and are oriented flush with the exterior surface of the body. The side panels are fastened to one another through the body so they are independent of the material of the body of the fishing lure.

Chen U.S. Pat. No. 6,794,440, issued Sep. 21, 2004 (and is hereby incorporated herein by reference as though fully set forth hereat) discloses at length various elastomeric polymers that are suitable for use in the present embodiments of elastomeric fishing lures. An extensive list of definitions of terms used in the sport of fishing is also included.

None of the above listed prior art lures performs adequately in maximizing the enjoyment that fishermen experience in catching fish. Development of a fishing lure which can optimally attract predator fish represents a great improvement in the field of sport fishing and satisfies a long felt need of the fisherman.

Reference to or incorporation herein of any prior art is not, and should not be taken as an acknowledgment that, absent the teachings herein, such prior art could reasonably be understood by one of ordinary skill in the art to be relevant to the invention that is claimed herein.

In the event of a conflict between any of the references that are incorporated herein by reference and the present disclosure, as between the two, the present disclosure shall prevail.

### SUMMARY OF THE INVENTION

Embodiments of the present invention include a fishing lure capable of mimicking the appearance and various motions of a wounded fish, worm, lizard, snake, or other natural food in the water. In certain specific embodiments it comprises a flaccid elastomeric body, approximating the shape of such natural food. The body includes a front end, a tail section, a tail end, and a spine.

The body, according to certain embodiments, is flaccid in the sense that it is capable of substantially holding its cross-sectional shape but not its lateral shape. That is, an elongated lure body, without a spine, will bend under its own weight when supported at approximately a single point or line, but the cross-sectional shape will remain substantially the same. Conventional flaccid elastomeric materials, for example, those disclosed by Chen U.S. Pat. No. 6,794,440, are among those that the flaccid elastomeric bodies may be constructed from. Other conventional elastomeric materials that are suitable for use according to the present invention include, for example, conventional silicon based polymers. The flaccid elastomeric bodies are too weak in bending strength to hold a motion defining shape. They typically bend under their own weight when supported only at one end or the other, but without permanent deformation. Fishing lures composed of flaccid elastomeric materials are sometimes referred to by those in the art as “soft plastic” lures. Such soft plastic lures are often composed of silicon polymers.

The spine according to certain embodiments is ductile in the sense that it is capable of being shaped through deformation by hand to a new form without breaking. Generally, a shaped spine will hold that new form while a lure including it is moved through water in a fishing operation. Generally, it will hold such a new form until it is reshaped by hand to a different form without breaking. The spine extends, for example, generally lengthwise through the body from generally forward of the front end, and exits the body approximately adjacent to but short of the tail section. The tail section has its root, that is, it begins where the flaccid elastomeric body becomes unsupported by the spine. The configuration of the body and the spine may be such that there is some small part of the tail section at its root that is constrained from free bending movement. Such constraint may be imposed, for example, by a thick cross-section of the flaccid elastomeric body, or by the presence of the spine next to the root of the tail section. The tail section is thus free to wiggle as permitted by the flaccid elastomeric material from which the body is composed. In certain embodiments, the spine comprises a ductile strip with a generally rectangular cross-section that is adapted to holding a shape that it is formed to. In some embodiments, ductile spines with round, oval, square, rectangular, or other cross-sections may be employed as a spine. According to certain embodiments, the spine defines the longitudinal shape of a major portion of the length of the lure, and the shape, particularly the longitudinal shape of the lure largely defines its motion as it is pulled through the water.

In certain embodiments, the tail section remains free to flutter as it is pulled through the water. The flaccid nature of the body allows the tail section to flutter in such a manner as to substantially mimic the motion of a predator fish's natural food. The flaccid elastomeric nature of the body aids in generating such natural motion.

The flaccid elastomeric nature of the body provides a feel to the lure that approximates the feel of the fish's natural food upon first contact. Thus, the fish is induced to hold onto and bite down on the lure rather than spitting it out as soon as it senses something unnatural about the lure. The nature of predator fishes' natural food is so complex that it is not possible to fully duplicate the feel of such natural food. Thus, an approximation of feel for purposes of first contact is all that is possible.

A ductily deformable spine that holds the elastomeric body in the desired motion defining configuration may further serve, for example, to provide convenient mounting locations for directly or indirectly mounting a fishing line at a front end, and a fishing hook at a rear end of a lure. In certain embodiments, the front and rear ends of the spine are typically exposed, but the mid-portion of the spine is generally embedded within or at least adhered to the flaccid elastomeric body of the lure. A fishing line attachment element is generally provided at approximately the front end of the spine. The attachment element should be close enough to the front end of the spine that the portion of the spine that projects forwardly beyond the attachment element does not interfere with the functioning of a fishing line when it is attached to the attachment element. A hook attachment element is typically provided at approximately the rear end of the spine. The hook attachment element should be close enough to the rear end of the spine that the portion of the spine that projects rearwardly beyond the hook attachment element does not interfere with the functioning of a fishhook when it is attached to the hook attachment element. The fishing line and hook attachment elements may, in certain embodiments be in the form of holes adjacent the front and rear ends of the spine. In some embodiments, the spine may have at least a forward hole at its forward end for mounting a fishing line, and a rear hole at its rear end for mounting a hook. Further embodiments may include other attachment elements such as, for example, clamps, snaps, clips, welds, brazes, solders, adhesives, and the like, if desired.

In certain embodiments, a hook attachment element is generally positioned in the tail section of the fishing lure spaced from the end of the lure approximately in the root of the tail section. In such embodiments, a fishhook mounted thereto extends along the tail section to approximately the rear end of the lure. Also, according to some embodiments, the hook is free to move relative to the rest of the lure. In this way, the hook appears to flutter when drawn through the water. The tail section is unreinforced by a spine and is too flaccid to hold a shape (other than cross-sectional shape) as it is drawn through the water. This allows the tail section to flutter in the water. This fluttering motion of the fishhook and tail section, according to certain embodiments, adds to the strike inducing motions of such embodiments of the lure.

In certain embodiments, the fishing line attachment element is generally positioned approximately adjacent to the front end of the lure. Various conventional forms of attachment may be used, including, for example, snap and swivel mechanisms. In embodiments where the fishing line is attached at the front of the lure more or less along the centerline of the lure, the lure is pulled through the water in a realistic forward direction by the fishing line.

Embodiments of the fishing lure when in use may also have a piece of bait placed on the hook. While not wishing to be bound to any theory, it is believed that this provides a smell that predator fish associate with natural food, thus further inducing the predator fish to strike the lure. The lure itself may be scented or not as may be desired. The providing of soft plastic lures that are scented is conventional. The flaccid elastomeric body of the lure in certain embodiments is generally composed of a soft polymeric material that readily absorbs scented oils.

A flaccid elastomeric body in certain embodiments is colored to resemble a particular prey fish or other natural food. Embodiments of the lure that resemble prey fish may, for example, be formed with a dark top and/or a speckled body, depending on which prey fish is being simulated. This is thought to help contribute a life-like appearance to the lure. Speckling and coloration is conveniently accomplished by, for example, filling the flaccid elastomeric body with reflective flakes and appropriate coloration.

Embodiments are utilized by a fisherman by bending the spine so that the fishing lure assumes the desired motion defining shape. A conventional fishing hook, for example, may be attached to the rear of the spine in conventional fashion, and a conventional swivel or snap and leader is attached to the forward end of the spine in conventional fashion. The various motions of embodiments of fishing a lure in the water that may be induced by a fisherman's controlled bending of a spine include, for example, spinning, wobbling, rolling, combinations thereof, or the like.

Certain embodiments comprise a fishing lure including a flaccid elastomeric body approximating the shape of a fish wherein the flaccid elastomeric body has a front end, a tail section,a tail end, and a spine member shape definingly associated with the flaccid elastomeric body. In such embodiments, the spine extends forward of the front end of the flaccid elastomeric body, and exits the body near the tail section, but short of the tail end. The spine has a forward end, a rear end, a forward hole at its forward end and a rear hole at is rear end. By reason of the spine, the fishing lure is ductily deformable into various motion defining shapes. The fish shaped flaccid elastomeric body, without the spine, is insufficiently strong in bending (too flaccid) to hold motion defining shapes.

The mass of a fishing lure with a flaccid elastomeric body is significant in determining the motion of the fishing lure in the water. It has been found that a fishing lure with a mass that provides substantially neutral buoyancy in water exhibits motion in the water that is very attractive to predator fish. Since the density of water varies slightly with temperature and the inclusion of dissolved or suspended foreign materials it is not possible to provide a fishing lure that has an exact neutral buoyancy. When a fishing lure exhibits substantially neutral buoyancy, a skilled fisherman can accommodate the minor variations from exact neutral buoyancy that it may exhibit in a given fishing situation. A skilled fisherman can accommodate as much as plus or minus 5 or 10 percent variation from the density of the water in which a fishing lure is immersed.

A more complete appreciation of the present invention and an understanding of its various embodiments may be achieved by referring to the accompanying drawings and description of illustrative embodiments.

### BRIEF DESCRIPTION OF THE DRAWINGS

Further advantages of the present invention may become apparent to those skilled in the art with the benefit of the following detailed description of the best mode of practicing the invention and illustrative embodiments, and upon reference to the accompanying drawings in which:

FIG. 1 depicts a diagrammatic side view of a typical prey fish body without a spine.

FIG. 2 depicts a diagrammatic cross-sectional view along line 2-2 in FIG. 1.

FIG. 3 depicts a diagrammatic top view of a typical prey fish body of FIG. 1.

FIG. 4 depicts a diagrammatic side view of an illustrative embodiment of a lure with a spine.

FIG. 5 depicts a diagrammatic top view of an embodiment of FIG. 4.

FIG. 6 depicts a diagrammatic side view of an embodiment illustrating coloring that may be applied.

FIG. 7 depicts a diagrammatic broken side view of an illustrative embodiment of the normally forward end of a lure.

FIG. 8 depicts a diagrammatic broken side view of an illustrative embodiment of the normally forward end of a lure including a shield member.

FIG. 9 depicts a diagrammatic broken side view of an illustrative embodiment of the normally forward end of a lure including a shield with an accessory mounting socket therein.

FIG. 10 depicts a diagrammatic broken cross-sectional view taken along line 10-10 in FIG. 9.

FIG. 11 depicts a diagrammatic broken side view of an illustrative embodiment of the normally forward end of a lure including a shield member having a motion enhancing configuration.

FIG. 12 depicts a diagrammatic side view of an additional embodiment of a spine.

FIG. 13 depicts a diagrammatic side view of an embodiment of an accessory that mounts, for example, in a socket of the embodiment of FIGS. 9 and 10.

FIG. 14 depicts a diagrammatic side view of a further embodiment of a spine having a flexible mid-portion.

FIG. 15 depicts a diagrammatic broken side view of an additional illustrative embodiment of the normally forward end of a lure including a shield member having a motion enhancing configuration.

FIG. 16 depicts a diagrammatic side view of an embodiment of a lure that mimics a worm.

FIG. 17 depicts a diagrammatic top view of an embodiment of a lure that mimics a lure with a split tail section.

### DETAILED DESCRIPTION OF THE PREFERRED EMBODIMENT

While illustrative embodiments have been illustrated for particular applications, it should be understood that the invention is not limited to these embodiments. Those having ordinary skill in the art and access to the teachings provided herein will recognize additional modifications, applications, and embodiments within the scope thereof and additional fields in which embodiments would be of significant utility.

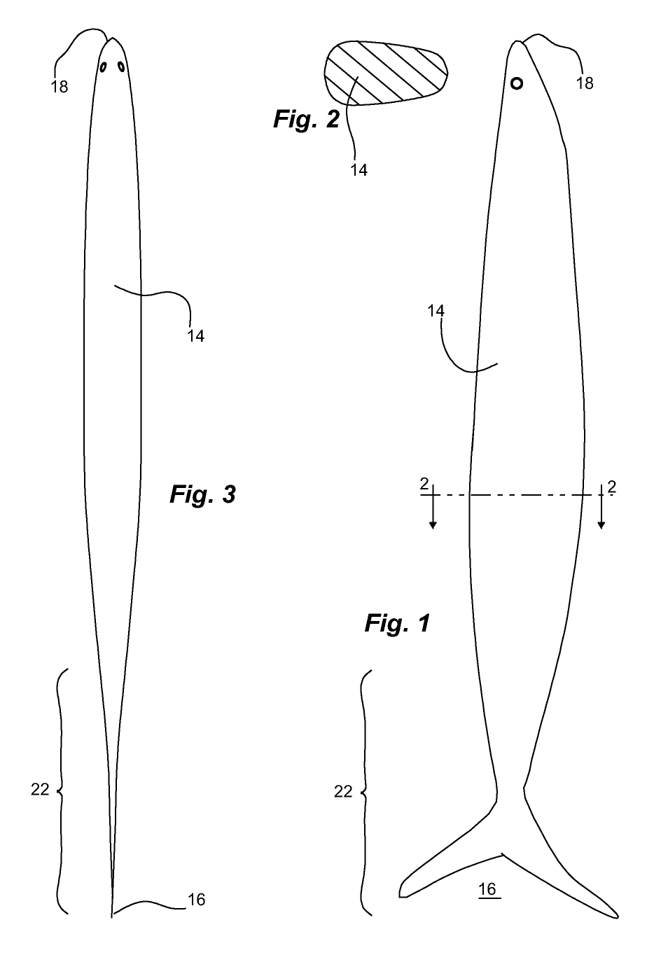

FIGS. 1, 2 and 3 diagrammatically illustrate a flaccid elastomeric body 14 of fishing lure 10. As can be seen the flaccid elastomeric body 14 approximates the shape of a prey fish, and has a front end 18 and a tail section 22. The natural shape of a prey fish is very complex and varies from species-to-species and from one fish to another, so it is not possible to exactly duplicate this shape. An approximation of this shape is all that is necessary for purposes of a very effective fishing lure. The flaccid elastomeric body 14 is fabricated to resemble the consistency of a live fish and can be made of any convenient plastic material such as vinyl, polyurethane, silicon polymers, and polyethylene. The flaccid elastomeric body 14 is not rigid enough to maintain a motion defining shape.

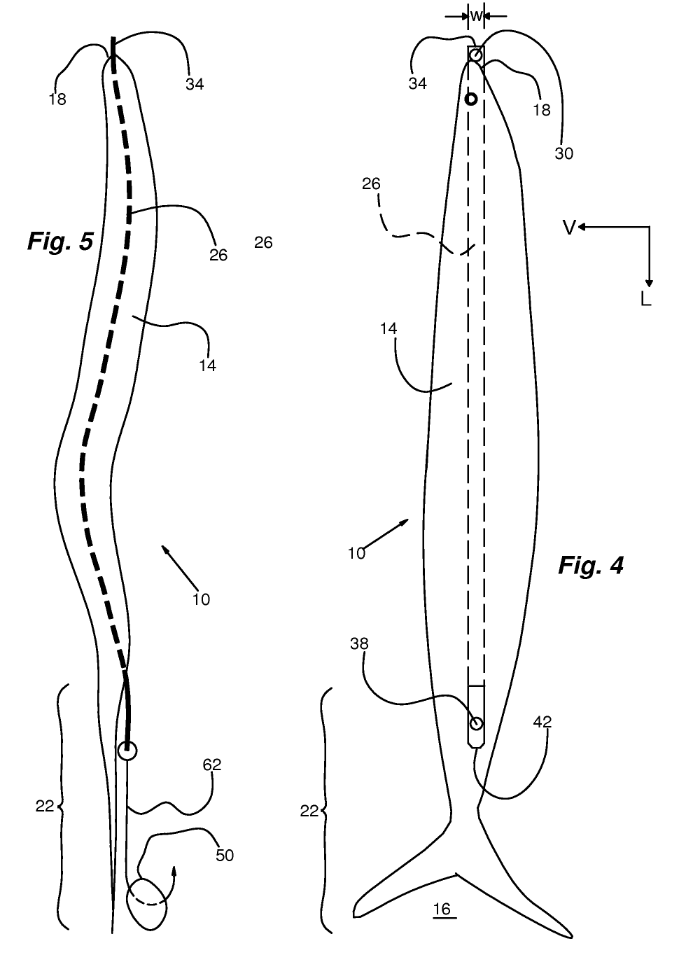

FIGS. 4 and 5 illustrate a spine 26 inserted with its width W in the vertical direction V, lengthwise L through the flaccid elastomeric body 14, and extends forward of the front end 18 and exits body 14 near but generally forward of tail section 22. Spine 26 has a forward hole 30 adjacent its forward end 34 and a rear hole 38 adjacent its rear end 42. Rear end 42 of spine 26 may be, for example, shaped as illustrated in FIG. 4. The ductility of spine 26 enables it to be bent to any desired shape. The ductility of spine 26 also enables it to be bent repeatedly into various different motion defining shapes without breaking. Spine 26 in some embodiments is made of metal, such as soft aluminum alloy or stainless steel and serves to hold the flaccid elastomeric body 14 in the desired motion defining configuration. In further embodiments, ductile plastic or composite materials may be employed as the material of construction for spine 26. In certain embodiments, spine 26 has a thickness that is from approximately 5 to 100 percent of the width W of the spine. Round, oval, square, rectangular, hollow or solid, or the like cross-sectional configurations may be employed if desired, provided the fishing lure with the spine associated with it is manually ductily deformable by a fisherman using only hands.

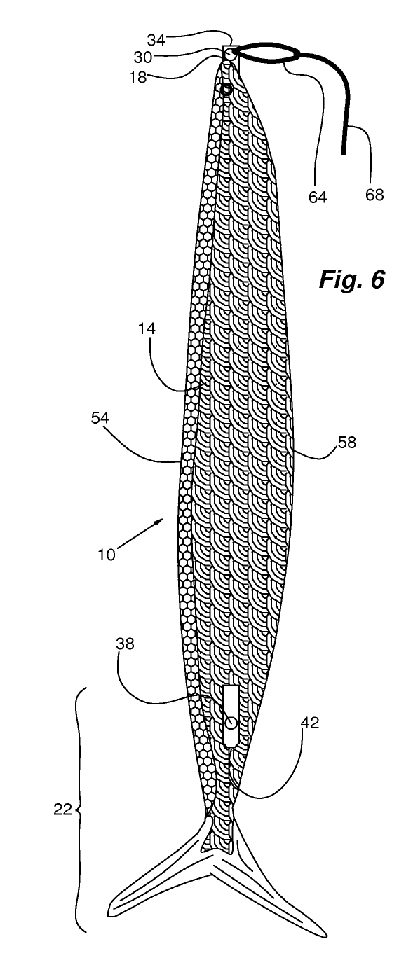

An embodiment in which the flaccid elastomeric body 14 is colored to resemble a fish, with dark top 54 and/or a speckled body 58 is illustrated in FIG. 6.

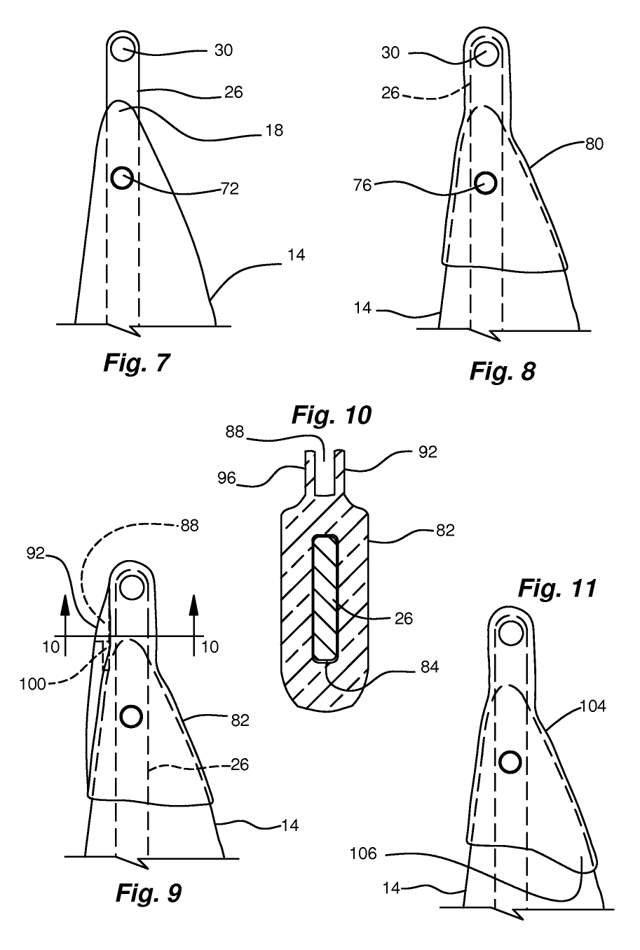

FIG. 7 illustrates the elements at the front end of an embodiment of a fishing lure. In the embodiment chosen for illustration, spine 26 enters flaccid elastomeric body 14 at about front end 18. The soft plastic from which flaccid elastomeric body 14 is made is subject to being torn away from front end 18 by flowing water as the fishing lure is pulled through the water. Such damage may progress so far that it destroys the lure, or at least changes the motion or attractiveness of the lure in unpredictable ways. Any debris that strikes front end 18 tends to tear the soft plastic away from the spine 18. An embodiment that provides an effective solution to this problem is illustrated in FIG. 8.

A shell 80, in the embodiment depicted in FIG. 8, is inserted over, substantially conforms to, and encloses front end 18. Shell 80 is substantially rigid in that it protects front end 18 from the force of water flowing relative to the lure, as well as from the impact of debris on front end 18. Shell 80 does not extend rearwardly far enough along flaccid elastomeric body 14 to significantly interfere with ductily deforming the fishing lure. That is, the fishing lure may be bent by hand to achieve whatever motion the user desires with shell 80 in place on the front end of the lure. Further, shell 80 should not add more than approximately 10, and in some embodiments, less than 5 percent to the mass of the fishing lure. Thus, the buoyancy of the fishing lure is not significantly altered by the addition of shell 80. Shell 80 conforms well enough to the front end of the flaccid elastomeric body 14 that, unless in an embodiment a shell is deliberately designed to influence the motion of the lure, it has no significant influence on the motion of the lure. In the embodiment chosen for illustration, shell 80 encloses both front end 18 and the forwardly exposed end of spine 26. Additional embodiments may leave the spine projecting through a close fitting opening in the front of the shell. Unless it is molded in place or otherwise fused or adhesively attached to the flaccid elastomeric body, the shell will only substantially conform to the body. It is not necessary to have a precision fit between the shell and the body. Gaps of as much as 5 to 20 thousandths of an inch at locations between the two are acceptable.

A mating aperture is provided in shell 80 in alignment with forward hole 30 for purposes of directly or indirectly mounting a fishing line. The fishing line mounting generally serves to help maintain shell 80 in position on front end 18. In various embodiments a shell may be slipped over the front end of the fishing lure after the flaccid elastomeric body is formed, or a shell may be formed into the flaccid elastomeric body as it is formed. In those embodiments where the shell is formed as one piece with the flaccid elastomeric body, the shell may be formed at the same time as the body, or separately from and then joined with the body.

In the embodiment of FIG. 8 the shell 80 defines a lip that projects slightly outwardly from the surface of the flaccid elastomeric body 14 at the rearward terminus of the shell 80. In further embodiments the terminus of the shell is embedded in the body so there is substantially no lip. The flaccid elastomeric body 14 in the embodiments of FIGS. 7 and 8 includes simulated eyes. Eye 72 in the flaccid elastomeric body 14 (FIG. 7) may be covered by a shell, as in FIG. 8. A simulated eye may be provided in the shell as shown at 76 (FIG. 8).

With particular reference to the embodiments of FIGS. 9 and 10, shell 82 is similar in form and function to shell 80, except shell 82 includes a mounting socket 100 that is adapted to receive an accessory such as, for example, mounting post 126 of lure mount 122 (FIG. 13) in an interference fit. This interference fit between socket 100 and mounting post 126 functions to prevent mounting post 126 from sliding axially along its major axis out of engagement with mounting socket 100. Shoulders 92 and 96 define therebetween a channel 88 that serves to guide mounting post 126 into mounting socket 100, and to engage both the mounting post 126 and the lure shaft 128 the elbow region 86 of lure mount 122. The engagement of elbow region 86 in channel 88 by shoulders 92 and 96 is also an interference fit. This interference fit in channel 88 serves to prevent mounting post 126 from rotating in mounting socket 100. Although the frictional engagement that results from the interference fits between lure mount 122 and shell 82 is generally sufficient to retain lure mount 122 and shell 82 in an assembled configuration, in additional embodiments, the two may be, for example, molded together, adhered together by softening and shaping a thermoplastic shell around the lure mount, by using an adhesive to affix the two together, or the like. A close fit between spine 26 and spine pocket 84 in shell 82 is shown in FIG. 10. This fit may be achieved in the same manner as just described between lure mount 122 and shell 82.

Lure mount 122 (FIG. 13) includes lure mounting eye 124 to which lures such as, for example, spinners, may be attached. The lure shaft 128 is long enough to space the lure from the fishing lure 10. In, for example, murky water, a flashing spinner attached to lure mount 122 may attract a predator fish to the lure 10.

In the embodiment of FIG. 11, shell 104 includes an extended skirt portion 106. Extended skirt portion 106 projects axially far enough along the flaccid elastomeric body of the fishing lure to function as an extended shield to protect the soft polymeric body from physical damage and to influence the interaction between the fishing lure and the water through which it is drawn. The action of water flowing over extended skirt portion 104 generally causes a fishing lure that is of such a mass that it has a generally neutral buoyancy to rise as it is pulled through the water.

In those embodiments wherein shells are employed they are rigid as compared to the flaccid elastomeric body of the fishing lure. Shells are substantially rigid in that they do not deflect under the force of flowing water in normal fishing use. The flaccid elastomeric bodies do deflect under the force of flowing water. Also, shells does not tear when impacted by debris. In normal fishing situations the flaccid elastomeric bodies tend to deform and ultimately tear at the leading end where the fishing lure first contacts water and/or debris that is flowing relative to it. Shells prevent such leading edges from deforming and tearing. In some embodiments, the walls of the shell are continuous, but other forms of shells are acceptable. For example, in some embodiments perforated or discontinuous walls are employed. Small areas of the incased body are exposed through such discontinuous walls, but such exposed areas are not large enough to subject the underlying body to deformation or tearing.

In the embodiment of FIG. 15, a shell 134 includes a bladder that is adapted to contain a gas for added buoyancy. In this embodiment the skirt of the shell 134 is extended to accommodate the bladder. If an embodiment of a fishing lure is, for example, nose heavy, this condition may be corrected by the inclusion of one or more bladders such as that illustrated at 136. Also, such bladders add buoyancy to the entire fishing lure.

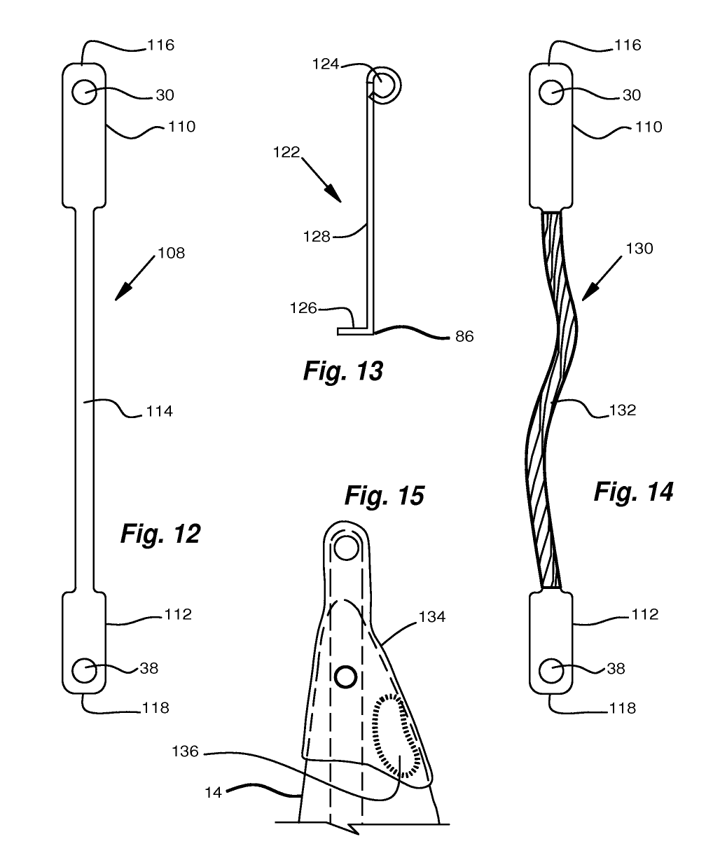

An embodiment of a spine is indicated generally at 108 in FIG. 12. The mid-section 114 of spine 108 has been reduced in size so as to reduce the overall mass of the spine without impairing its ability to be deformed into a desired motion defining shape. The size of mid-section 114 is such that spine 108 will hold whatever motion defining shape it is formed into. This contributes to the buoyancy of the fishing lure with which spine 108 is associated. Spine 108 has a first end 116 and a second end 118, a forward hole 30 and a rear hole 38. First tab 110 is of sufficient size to provide the needed strength to permit the attachment of a fishing line (not shown) to forward hole 30. Second tab 112 is likewise of sufficient size to provide the needed strength to permit the attachment of a fishhook (not shown) to rear hole 38.

FIG. 14 illustrates an embodiment of a spine 130 in which mid-section 132, between first tab 110 and second tab 112, is a multi-strand cable. Mid-section 132 is capable of approximately holding a shape to which it is deformed, but with a slight flexibility so the flaccid elastomeric body flexes slightly while still maintaining approximately its motion defining shape. The body of a real wounded prey fish or other natural food would likewise exhibit some slight flexibility. The approximate holding of a motion defining shape allows the motion of the fishing lure in the water to vary slightly with time. This all adds to the realism of the fishing lure. The approximate holding of shape is sufficient to allow the fishing lure to vary slightly the limits of the excursions its motion exhibits, but not the nature of the motion. If a fishing lure is configured to roll, the speed or diameter of the roll may vary slightly, but the excursion permitted by the flexing of the spine does not allow the user defined motion to change, for example, from a roll to a wobble. The user of the fishing lure defines the nature of the motion exhibited by the lure by bending the lure to a desired shape. The limited flexing of the fishing lure defines from moment-to-moment the limits of the excursions of the predefined motion.

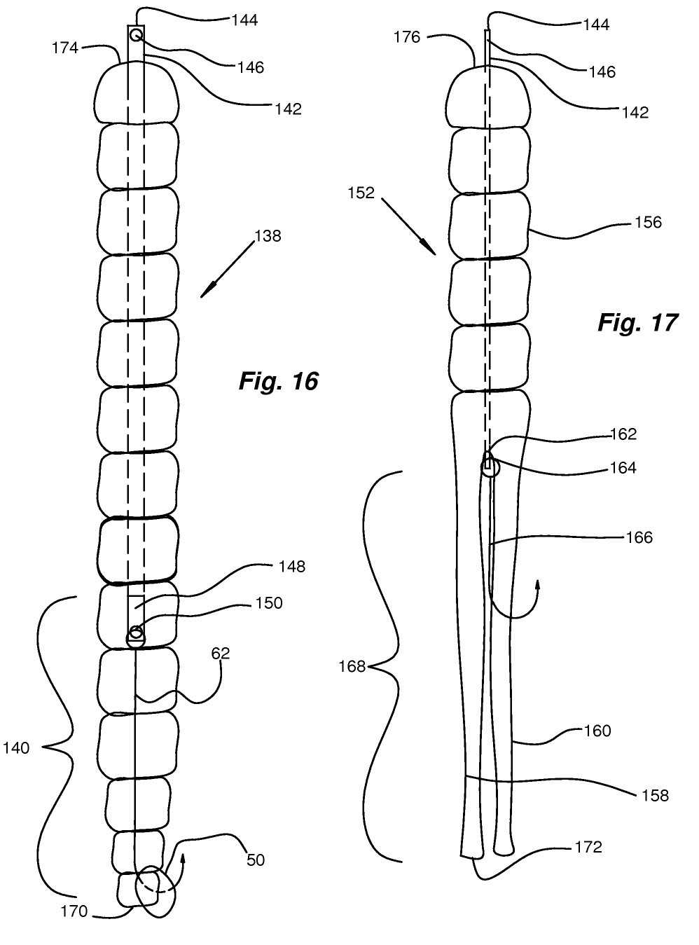

With particular reference to the embodiment of FIG. 16, there is illustrated generally at 138 a fishing lure. Fishing lure 138 is constructed with a flaccid elastomeric body, and a spine extending along the major axis of the fishing lure to approximately tail section 140. Fishing lure 138 is in the form of a worm (a natural food for predator fish) with a front end 174, a tail end 170, and a tail section 140. A spine projects from front end 174 to provide an exposed front portion 142, and, from a location approximately at the attached end of tail section 140, an exposed rear portion 148. Spaced from forward tip 144 along the major axis of the spine in exposed front portion 142 is forward hole 146. Spaced along the major axis of the spine in exposed rear portion 148 is rear hole 150. Fishhook 62 is mounted to exposed rear portion 148 through an articulated connection to rear hole 150. This articulated connection allows fishhook 62 to flutter as fishing lure 138 is pulled through the water. A piece of bait 50 is shown impaled on fishhook 62 to illustrate the fishing lure as it might appear in one configuration during actual use. The presence of the bait 50 tends to cause the fishhook 62 to flutter in the water. Tail section 140 is unsupported by a spine so it is free to flutter as it is drawn through the water.

With particular reference to the embodiment of FIG. 17, a fishing lure is indicated generally at 152. Fishing lure 152 is constructed with a flaccid elastomeric body 156, and a spine extending along the major axis of the fishing lure to the root of tail section 168. Flaccid elastomeric body 156 has a tail end 172 and a front end 176. A spine projects from front end 176 to provide an exposed front portion 142, and, from a location at the root of tail section 168, an exposed rear portion 162. Spaced from forward tip 144 along the major axis of the spine in exposed front portion 142 is forward hole 146. Spaced along the major axis of the spine in exposed rear portion 162 is rear hole 164. Fishhook 166 is mounted to exposed rear portion 162 through an articulated connection to rear hole 164. This articulated connection allows fishhook 166 to flutter as fishing lure 152 is pulled through the water. Tail section 168 is composed of trailing appendages 158 and 160.

Embodiments may be made, for example, by fabricating a flaccid elastomeric body approximating the shape of a natural food item, with a front end, a tail end, and a tail section. A spine is provided. A spine may, for example, be molded into the body, inserted into the body after the body is produced, or simply adhered to the body so as to define the shape of the body. Spines may have various cross-sections, see for example, FIGS. 4 and 5 where spine 26 with, for example, its width W in the vertical direction V, and extending lengthwise L of the lure (see FIG. 4) is provided within or at least adhered to the flaccid elastomeric body 14 except in the tail section 22. In the illustrated embodiment, spine 26 extends from slightly forward of the front end 18 into flaccid elastomeric body 14, and exits the flaccid elastomeric body 14 at or near the tail section 22, but short of the tail end of the fishing lure 10. In those embodiments where a shell is provided, the shell may be molded in place with the flaccid elastomeric body, or it may be placed on after the body molding step is accomplished. More than one spine may be used is desired. The multi-strands of spine 130 may be considered to be a multiplicity of spines.

The present invention is utilized by, for example, bending the spine by hand so that the fishing lure assumes the desired motion defining shape. A fishhook is attached (usually be the fisherman) to the rear hole in the spine in conventional fashion. A conventional fishing line assembly is attached, for example, a swivel and leader, to the forward hole in the spine in conventional fashion. When desired, bait is attached to the fishhook by a fisherman in a conventional fashion. Frozen bait is conveniently used for this purpose. In this way, a real scent of a predator fish's natural food is provided. A rear hole in a spine at approximately the rear end of the spine permits a fishhook to be attached. The positioning of this rear hole relative to the flaccid elastomeric body of the fishing lure is such that it allows an attached fishhook to extend, for example, approximately to the rear of the lure. Also, the attachment of a fishhook to the rear hole is such that the fishhook is free to flutter as it moves through the water. This further induces a predator fish to strike the fishing lure.

Embodiments of a fishing lure will, for example, mimic a wounded bait fish by a slow rolling motion as they are pulled through the water. Copying the rolling motion of a wounded prey fish, a predator fish, for example, a salmon, will immediately induce the predator fish to strike the lure. The rolling motion is adjustable by adjusting the bend in the spine, allowing the lure to roll slowly in large circles or roll faster or spin in smaller circles. The fishing lure may likewise be adjusted, for example, to wobble in the water, or to wobble and roll. A fisherman is free to adjust various embodiments of the fishing lure to provide whatever simple or compound motion may be desired.

Embodiments of a fishing lure comprising a body having a mass and being elongated. The body approximating the shape of a predator fish's natural food. The body being flaccid and elastomeric, and having a front end, a tail section, and a tail end. The fishing lure includes a spine, which is shape definingly associated with the body. The spine is ductile, extends forward of the front end, and terminates at the root of the tail section. The spine has a forward end and a rear end. The forward end is adapted to being mounted to a fishing line, and the rear end is adapted to flutterably mount a fishing hook. The fishing lure is ductily deformable into various motion defining shapes. The body, without the spine, is insufficiently strong to hold motion defining shapes. The mass of the fishing lure is such that the fishing lure has a substantially neutral buoyancy in water.

Further embodiments comprise a fishing lure comprising a body, which body is elongated and approximating the shape of a predator fish's natural food. The body is flaccid and elastomeric, and has a front end, a tail section, and a tail end The fishing lure includes a spine, shape definingly associated with the body. The spine is ductile, extends forward of the front end, terminates at the root of the tail section. The spine has a forward end, and a rear end. The forward end is adapted to being mounted to a fishing line, and the rear end is adapted to flutterably mount a fishing hook. The fishing lure is ductily deformable into various motion defining shapes. The body without the spine is insufficiently strong to hold the motion defining shapes. The tail section extends free flutterably rearward of said rear end. The fishing lure includes a shell substantially enclosing and conforming to the front end. The shell is substantially rigid and adapted to protecting the front end from deforming under the force of water flowing relative to the front end. The spine extends through the shell at approximately the front end. The shell does not extend far enough along the body to significantly interfere with ductily deforming the fishing lure. The fishing lure has a mass, which is such that the fishing lure has a substantially neutral buoyancy in water.

Unless otherwise defined, all terms used herein have the meaning defined in Webster's Third New International Dictionary of the English language unabridged, copyright 1981 G. & C. Merriam Co. In case of conflict, the present specification, including definitions, will control.

As used herein “comprise” and variations thereof, such as “comprising”, “comprises”, and “comprised”, are not intended to exclude other additives, elements, components or steps.

As used herein “include” and variations thereof, such as “including”, “includes”, and “included”, are not intended to exclude other additives, elements, components or steps.

All of the disclosed embodiments of the invention disclosed herein may be made and used without undue experimentation in light of this disclosure. Although the best mode of carrying out the invention contemplated by the inventor is disclosed, practice of the invention is not limited thereto. Thus, the present invention has been described herein with reference to particular embodiments for particular applications. Those having ordinary skill in the art and access to the present teachings will recognize additional modifications, applications and embodiments within the scope thereof. It is therefore intended by the appended claims to cover any and all such applications, modifications and embodiments within the scope of the present invention.

What is claimed is:

1. A fishing lure comprising:
a body having a mass and being elongated, said body approximating the shape of a predator fish's natural food; said body being flaccid and elastomeric, and having a front end, a tail section, and a tail end; and
a spine, shape definingly associated with said body, said spine being ductile, extending forward of said front end, terminating approximately short of said tail section, said spine having a forward end, a rear end, said forward end being adapted to being mounted to a fishing line, said rear end being adapted to flutterably mount a fishing hook, said fishing lure being ductily deformable into various motion defining shapes, said body without said spine being insufficiently strong to hold said motion defining shapes, said mass being such that said fishing lure has a substantially neutral buoyancy in water.

2. A fishing lure of claim 1 including a said fishing hook extending substantially to said tail end.

3. A fishing lure of claim 1 wherein said body approximates the shape of a prey fish.

4. A fishing lure of claim 1 wherein said body approximates the shape of a worm.

5. A fishing lure of claim 1 including a shell substantially enclosing and conforming to said front end, said shell being substantially rigid and adapted to protecting said front end from deforming under the force of water flowing relative to said front end, said spine extending through said shell at approximately said front end, said shell not extending far enough along said body to significantly interfere with ductily deforming said fishing lure.

6. A fishing lure of claim 3 wherein said shell includes a socket for mounting an accessory.

7. A fishing lure comprising:
a body, said body being elongated and approximating the shape of a predator fish's natural food; said body being flaccid and elastomeric, and having a front end, a tail section, and a tail end;
a spine, shape definingly associated with said body, said spine being ductile, extending forward of said front end, terminating approximately short of said tail section, said spine having a forward end, a rear end, said forward end being adapted to being mounted to a fishing line, said rear end being adapted to flutterably mount a fishing hook, said fishing lure being ductily deformable into various motion defining shapes, said body without said spine being insufficiently strong to hold said motion defining shapes, said tail section extending free flutterably rearward of said rear end; and
a shell substantially enclosing and conforming to said front end, said shell being substantially rigid and adapted to protecting said front end from deforming under the force of water flowing relative to said front end, said spine extending through said shell at approximately said front end, said shell not extending far enough along said body to significantly interfere with ductily deforming said fishing lure, said fishing lure having a mass, said mass being such that said fishing lure has a substantially neutral buoyancy in water.

8. A fishing lure of claim 1 in which said body is colored to resemble a predator fish's natural food.

9. A fishing lure of claim 7 wherein said shell includes a bladder.

10. A fishing lure of claim 1 wherein said spine comprises a multi-strand cable.

11. A fishing lure of claim 7 wherein said shell includes perforated walls.
